(19) United States
(12) Patent Application Publication
(10) Pub. No.: US 2023/0029177 A1
(43) Pub. Date: Jan. 26, 2023

(54) SYSTEMS AND METHODS FOR EXPOSING ALTERNATE SHIPPING SERVICE PROVIDER SERVICES IN SHIPPING MANAGEMENT SYSTEMS

(71) Applicant: Stamps.Com Inc., El Segundo, CA (US)

(72) Inventors: Kristen Clair Purvis, Canton, GA (US); Shea Robert Felix, Falls Church, VA (US); Joerg Schmidt, Ball Ground, GA (US)

(21) Appl. No.: 17/381,082

(22) Filed: Jul. 20, 2021

(51) Int. Cl. G06Q 10/08; G06Q 30/06; G06Q 30/00; G06F 21/45

(52) U.S. Cl. CPC G06Q 10/08345; G06Q 30/0641; G06Q 10/08355; G06Q 10/0833; G06Q 30/018; G06F 21/45; G06Q 50/26

(57) ABSTRACT

Systems and methods which provide for exposing alternate shipping service provider services in shipping management systems are described. Embodiments provide a generic alternate carrier component used to configure configured alternate carrier components of carrier support logic for exposing corresponding alternate shipping service providers for selection and use by users of a shipping management system. A generic alternate carrier component may be configured for a respective alternate shipping service provider for interfacing selected carrier shipping services offerings supported by the alternate shipping service provider with a shipping management platform of a shipping management system. Carrier support modules may be provided for each shipping service provider of a plurality of shipping service providers, wherein the carrier support modules may be configured to interface services logic for a corresponding shipping service provider with a shipping management platform using one or more configured alternate carrier components.

### TECHNICAL FIELD

The invention relates generally to shipment of items and, more particularly, to providing for exposing alternate shipping service provider services in shipping management systems.

### BACKGROUND OF THE INVENTION

The shipment of items, such as new and used goods shipped from merchants or other shippers to purchasers or other recipients, has been commonplace for years. For example, it is commonplace for various merchants, whether they be “brick and mortar” merchants, online merchants, or sellers through an electronic marketplace (e.g., eBay, Amazon Marketplace, Shopify, etc.), to ship goods using a number of forms of shipping services and media, such as letters, flats, and parcels, via various shipping service providers.

With the advent of the Internet and the proliferation of innumerable e-commerce merchants and marketplaces, not only have the number of items shipped increased appreciably in recent years, but so too have the number of shippers and recipients of such items. Accordingly, there is an increasing number of mid-sized, small, and even individual shippers shipping an increasing number of items. Such smaller volume shippers (i.e., mid-sized, small, and individual shippers as compared to large scale businesses traditionally involved with high volume shipping) are typically less sophisticated with respect to shipping and thus are often not in a position to consider or take advantage of some otherwise available options with respect to shipping service providers and/or their particular shipping services.

Traditional shipping service providers (e.g., shipping service providers traditionally used in the context of relatively small volume shipping or relatively unsophisticated shippers, referred to as principal shipping service providers herein), such as the United States Postal Service (USPS), United Parcel Service (UPS), Federal Express (FedEx), and Dalsey, Hillblom and Lynn (DHL) providing a number of end to end conventional shipping services, are often selected by shippers (e.g., individual, small, and mid-sized shippers) due to their availability and relatively simple shipping services selections. For example, such principal shipping service providers typically have robust computer platforms providing readily available and intuitive user interfaces (e.g., via direct shipping service provider portal access) and/or facilitating exposure in shipping management systems (e.g., shipping management platforms available commercially as SHIPSTATION, SHIPWORKS, SHIPPINGEASY, ENDICIA, etc.), whereby selection of a principal shipping service provider and their shipping services is simple and convenient.

Despite their nearly ubiquitous presence and relative ease of use, principal shipping service providers and the shipping services available from principal shipping service providers may not necessarily be optimal with respect to any particular item shipment or situation. For example, the shipping services of principal shipping service providers are often available only at retail type pricing levels to many shippers (e.g., individual, small, and/or mid-sized shippers), although shipping services provided by less-traditional shipping service providers (e.g., shipping service providers less-traditionally used in the context of relatively small volume shipping or relatively unsophisticated shippers, referred to as alternate shipping service providers herein) or even excess capacity available from various shipping service providers may be suitable and available at lower pricing levels (e.g., wholesale). As another example, some services performed with respect to item shipment, such as customs processing and clearance, may be better served by some alternate shipping service providers.

Some examples of alternate shipping service providers include local and regional couriers, trucking companies providing truckload (TL) services and/or less than truckload (LTL)/less than container load (LCL) services (e.g., J.B. Hunt, Arkansas Best Freight (ABF), YRC Freight, etc.), and/or the like, which often do not provide full retail end user shipping services (e.g., end to end conventional shipping services, home delivery or delivery to other than a loading dock, etc.). A further example of alternate shipping service providers includes shipping consolidators, such as RR Donnelley (RRD), International Bonded Couriers (IBC), APC Postal Logistics, and/or the like, which often offer shipping services outside of the mainstream retail shipping services market (e.g., may not be readily available to or accessible by less sophisticated shippers).

Shipping consolidators, also known as postal consolidators, freight consolidators, or Postal Qualified Wholesalers (PQWs), typically group packages from multiple shippers that can share a portion of the shipping route (e.g., a same enroute segment, a same destination region or country, etc.), often offering shipping services at reduced rates (e.g., as compared to more traditional shipping service providers) and/or robust shipping services or shipping services tailored for particular needs (e.g., customs processing, special handling, etc.). Shipping consolidators may utilize various means by which to provide shipping services, including using the services of other shipping service providers (e.g., principal and/or alternate shipping service providers). For example, shipping consolidators may purchase or contract for shipping capacity (e.g., surplus capacity, capacity sold in bulk, LTL/LCL capacity, etc.) from various shipping service providers, and offer shipping services to shippers at rates lower than conventional shipping services otherwise using the same or similar means of conveyance. Additionally or alternatively, shipping consolidators may partner with one or more shipping service providers (e.g., the USPS and the local post offices of countries around the world) to provide shipping services with respect to the induction segment (e.g., picking up shipped items from shippers, providing an initial point for shippers to drop off shipped items, etc.) and/or delivery segment (e.g., providing delivery of shipped items to a recipient address, providing a point of pickup for recipients, etc.). Shipping consolidators may likewise partner with one or more additional services providers for proving various services related to the shipment of items (e.g., customs processing, customs logistics, international fee settlement using a commercially cleared service, etc.). In operation, a shipping consolidator may consolidate or aggregate item shipments from a plurality of shippers (later separating the items for delivery the respective intended recipients) to leverage shared services and provide discounted and/or robust services to shippers. For example, using such consolidation, shippers may more easily access otherwise complicated or less readily available services (e.g., international shipping, LTL/LCL shipping, customs processing, etc.) to more conveniently ship items at affordable rates.

In contrast to principal shipping service providers, shipping consolidators and other alternate shipping service providers often do not have the same widespread exposure or ready availability to shippers. For example, alternate shipping service providers often have computer platforms supporting large volume shippers and are not readily accessible to individual or small shippers, and often even mid-sized shippers. If such alternate shipping service providers are to have exposure in shipping management systems, custom software modules must typically be uniquely developed with respect to each shipping management platform for each alternate shipping service for which exposure is to be provided. In addition to requiring significant programing and development resources to initially implement, applying various changes (e.g., changes in shipping services supported, changes in underlying shipping service providers, etc.) generally requires further, significant programming and development resources. Accordingly, although often offering shipping services at reduced rates and/or robust shipping services or shipping services tailored for particular needs, the selection and use of alternate shipping service providers, such as shipping consolidators, is inconvenient or unavailable to many shippers.

### BRIEF SUMMARY OF THE INVENTION

The present invention is directed to systems and methods which provide for exposing various alternate shipping service provider services in shipping management systems. For example, shipping services offered by alternate shipping service providers such as shipping consolidators or other shipping service providers less-traditionally used in the context of relatively small volume shipping or relatively unsophisticated shippers may be provided exposure through one or more shipping management systems according to embodiments of the invention. A shipping management system may, for example, comprise a shipping management platform configured to provide automation of tasks associated with the shipment of items, such as management of item orders, management of shipping service providers and shipping services, managing picking and packing of items for order fulfilment, generation of invoices, packing slips, manifests, shipping labels, and postage or other prepaid shipping indicia, and tracking of shipment of items through a shipping service provider. An alternate shipping service provider may, according to some examples, be provided exposure within a shipping management system to users (e.g., shippers, purchasers or other recipients, etc.) similar or equal to that of the exposure of principal shipping service providers (e.g., shipping service providers traditionally used in the context of relatively small volume shipping or relatively unsophisticated shippers) within the shipping management system. Accordingly, shipping services of alternate shipping service providers, such as shipping services offered at reduced rates, robust shipping services or shipping services tailored for particular needs, etc., may be made readily available for the convenient selection and use by various users (e.g., less-sophisticated and/or low volume shippers and their recipients).

Embodiments of the invention provide a generic alternate carrier component used to configure one or more configured alternate carrier components of carrier support logic in a shipping management system for exposing corresponding alternate shipping service providers for selection and use by shippers and/or other users of the shipping management system. For example, a generic alternate carrier component of some embodiments provides a framework (e.g., software or logic construct) configurable to interface selected carrier shipping services offerings with a shipping management platform of the shipping management system. Accordingly, an alternate shipping service provider may be exposed by the shipping management platform as a carrier option available to users (e.g., shippers of various items, recipients/intended recipients of various items, etc.) of a shipping management system. A generic alternate carrier component of embodiments may comprise logic supporting various functionality, such as supporting updating one or more marketplaces via the shipping management platform with information regarding shipping activity, integration with enterprise resource management (ERP) systems and/or other back office systems, etc. The users of embodiments may access, query, update, utilize, or otherwise interact with shipping service offerings supported by a respective alternate shipping service provider via a user interface or other portal provided by the shipping management platform.

In operation according to embodiments of the invention, an instance of a generic alternate carrier component is configured for a respective alternate shipping service provider for interfacing selected carrier shipping services offerings supported by the alternate shipping service provider with a shipping management platform of a shipping management system. Configuration of a generic alternate carrier component may, for example, include designating one or more carrier shipping services of a plurality of carrier shipping services as supported carrier shipping services that are supported by the first alternate shipping service provider, providing alternate shipping service provider account details corresponding to the supported carrier shipping services, providing alternate shipping service provider services rules for implementation of the supported carrier shipping services as supported by the alternate shipping service provider, selecting one or more carriers from a plurality of shipping service providers as supported carriers that are supported by the alternate shipping service provider, etc. Accordingly, a configured alternate carrier component tailored or otherwise designed for the respective alternate shipping service provider may be provided by configuring an instance of the generic alternate carrier component of embodiments.

In some embodiments, carrier support modules may be provided for each shipping service provider of a plurality of shipping service providers (e.g., a plurality of principal shipping service providers). The carrier support modules may be configured to interface services logic for a corresponding shipping service provider with a shipping management platform. For example, a carrier support module may interface services logic for a corresponding shipping service provider with a shipping management platform via one or more carrier components (e.g., configured alternate carrier components, principal carrier components, etc.). Carrier support modules of embodiments may comprise a set of services that are selectable by an alternate shipping service provider for offering through the shipping management system. Accordingly, in operation according to some embodiments, a configured alternate carrier component may interface the carrier shipping services supported by a corresponding alternate shipping service provider with the shipping management platform in a carrier option exposed for the alternate shipping service provider. Carrier support modules of embodiments may comprise various logic for facilitating carrier shipping services supported by an alternate shipping service provider, such as logic to provide routing based off of alternate shipping service provider services rules, logic to provide tracking based off of alternate shipping service provider services rules, logic to support compliance with shipping rules of the corresponding shipping service provider, logic to support labeling, rating, and manifesting with respect to the corresponding carrier.

After being configured for a respective alternate shipping service provider, a configured alternate carrier component of embodiments may be interfaced with a shipping management platform to expose the alternate shipping service provider as a carrier option available to the users of the shipping management system. Interfacing a configured alternate carrier component with the shipping management platform may, for example, configure the shipping management system to present the alternate shipping service provider as a shipping service provider option with respect to one or more principal shipping service providers (e.g., USPS, UPS, FedEx, DHL, etc.). Additionally or alternatively, interfacing a configured alternate carrier component with the shipping management platform may, for example, configure the shipping management system to present the alternate shipping service provider as a shipping service provider option with respect to other alternate shipping service provider.

Implementation of alternate carrier components according to embodiments of the invention facilitates simplified addition of alternate shipping service providers as carrier options of a shipping management system. For example, development of custom, unique software modules for exposure of alternate shipping service providers in shipping management systems may be avoided through the use of generic alternate carrier components configured as instances of configured alternate carrier components for corresponding alternate shipping service providers. Moreover, alternate carrier components implemented in accordance with concepts herein facilitate altering one or more aspects of the configured alternate carrier component to dynamically change at least one service (e.g., change shipping services supported, change underlying shipping service providers, etc.) exposed for the first alternate shipping service provider to users through the shipping management system. For example, use of significant programming and development resources may be avoided in implementing various changes to the services offered by an alternate shipping service provider by changing one or more aspects of the configuration of a corresponding configured alternate carrier component.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a high level block diagram of a system adapted according to concepts of the present invention;

FIG. 2 shows a functional block diagram of a portion of the shipping management system of FIG. 1 according to some embodiments of the present invention;

FIG. 3 shows a functional block diagram providing further detail with respect to an embodiment of the carrier support system of FIG. 2 according to some embodiments of the present invention; and

FIG. 4 shows a flow diagram of a process for exposing shipping services of an alternate shipping service provider to users of the shipping management system of FIG. 1 according to some embodiments of the invention.

### DETAILED DESCRIPTION OF THE INVENTION

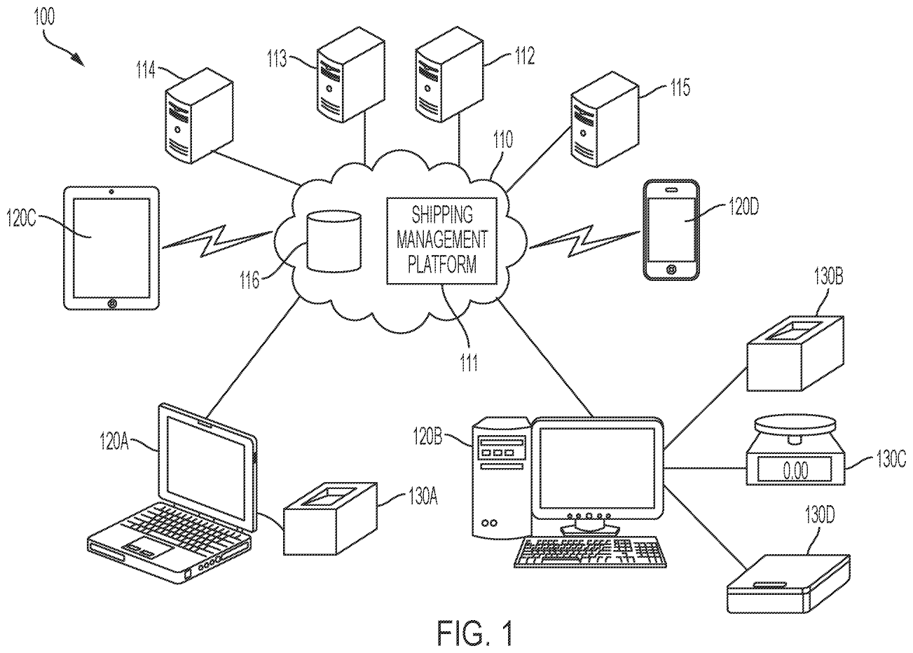

FIG. 1 shows an embodiment of shipping management system 100 adapted to facilitate exposing alternate shipping service provider services in the shipping management system according to concepts of the present invention. Shipping management system 100 of the illustrated embodiment includes various platforms and systems operable to provide functionality with respect to shipment of items, such as from merchants or other shippers to purchasers or other intended recipients. In particular, shipping management system 100 of the illustrated example includes shipping management platform 111, carrier support system 112, shipping service provider system 113, postage system 114, electronic marketplace system 115, storage 116, and user systems 120 in communication via network 110 for providing various shipping management functions.

The illustrated embodiment of shipping management system 100 shows a representative example of the number and configuration of various systems and platforms therein for providing functionality with respect to various users of the shipping management system. It should be appreciated, however, that the particular number and configuration shown is simplified in order to facilitate an understanding of the concepts of the present invention, and embodiments of the present invention are not limited to application to the particular representative number and configuration shown. Embodiments of shipping management system 100 may, for example, comprise a plurality of shipping service provider systems, postage systems, electronic marketplace systems, and/or storage systems. Further, although shown as implemented separately in the illustrated embodiment of shipping management system 100, it should be appreciated that various ones of the platforms and systems, or some portion thereof, may be combined. For example, a shipping management platform and carrier support system of embodiments of shipping management system 100 may be integrated into a common platform.

Network 110 of the illustrated embodiment provides communication links facilitating the communication between various systems and components of shipping management system 100, such as by and between some or all of shipping management platform 111, carrier support system 112, shipping service provider system 113, postage system 114, electronic marketplace system 115, storage 116, and/or user systems 120A-120D. Accordingly, network 110 may comprise any number of network configurations, such as the Internet, an intranet, the public switched telephone network (PSTN), a local area network (LAN), a metropolitan area network (MAN), a wide area network (WAN), a cellular network, a wireless network, a cable transmission network, and/or the like. The communication links between various nodes of the network may comprise wired links, wireless links, and combinations thereof. One or more interfaces, such as may comprise appropriate application programming interfaces (APIs), may be included in or otherwise provided with respect to one or more of the systems and components of the shipping management system to provide data exchange and/or other functionality described herein.

Shipping management platform 111 of embodiments of shipping management system 100 is operable to provide various functionality associated with the processing and shipment of items. Shipping management platform 111 of embodiments may, for example, provide functionality for the processing and shipment of items by a merchant or other shipper to a purchaser or other recipient, for managing and tracking shipment of items, as well as for the processing and return shipment of such items by the purchaser or other recipient to the merchant or other original shipper. Functionality provided according to embodiments of shipping management platform 111 may, for example, include functionality for processing of item purchase transactions, managing item fulfilment, managing item shipping, generating shipping labels, generating postage indicia, tracking of shipment of items through shipping service providers, authorizing returns, and/or the like. Additionally, embodiments of shipping management platform 111 may provide for the automation of tasks associated with the shipment of items, including order management, picking and packing of items for order fulfilment, generation of invoices, packing slips, manifests, shipping labels, and postage or other prepaid shipping indicia, updating and/or reporting tracking information, and/or the like. Embodiments of shipping management platform 111 provide a multi-carrier shipping management system capable of providing shipping functionality (e.g., rating, shipping indicia generation, packing list printing, shipping label printing, tracking, carrier pickup request, manifest printing, account management and payment, etc.) for a plurality of shipping service providers (e.g., USPS, UPS, FedEx, DHL, etc.).

The illustrated embodiment shows a cloud-based implementation of shipping management platform 111 (e.g., shipping management platform 111 is shown as present in network 110 of shipping management system 100 of the illustrated embodiment). Shipping management platform 111 of some embodiments may comprise computer executable code executing on one or more processor-based systems (e.g., web servers) deployed in network 110. For example, shipping management platform 111 may comprise a cloud-based deployment of a multiuser application which is stored and executed by computing equipment (e.g., one or more processors, such as a CORE or PENTIUM processor available from Intel, Inc.; requisite computer/processor readable memory, such as random access memory (RAM), read only memory (ROM), flash memory, disk memory, solid state disk (SSD) memory, optical memory, and/or the like; and input/output components, such as display, network interface card (NIC), keyboard, digital pointer, printer, and/or the like; coupled to a processor of the one or more processors via a data bus and disposed in the “cloud” of network 110).

It should be appreciated that although a cloud-based application environment is shown for shipping management platform 111 in the embodiment of FIG. 1, embodiments of the present invention may be implemented using additional or alternative configurations, such as using one or more locally disposed applications, using a distributed application topology, etc. Similarly, it should be appreciated that the “cloud” environment associated with network 110 may comprise applications, systems (e.g., carrier support system 112, shipping service provider system 113, postage system 114, electronic marketplace system 115, etc.), devices, etc. (e.g., storage 116) in addition to or in the alternative to shipping management platform 111, one or more of which (e.g., carrier support system 112, shipping service provider system 113, postage system 114, electronic marketplace system 115, and/or storage 116) may be utilized by or otherwise operable with shipping management platform 111 for providing functionality as described herein.

Shipping management platform 111 may, according to some examples, comprise a system providing various desired functionality in the form of software as a service (SaaS), infrastructure as a service (IaaS), platform as a service (PaaS), integration platform as a service (iPaaS), unified communications as a service (UCaaS), etc. For example, shipping management platform 111 may comprise shipping management functionality of one or more service environments providing shipping management, such as SHIPSTATION provided by Auctane LLC of Austin Tex., SHIPPINGEASY provided by ShippingEasy, Inc. of Austin Tex., and/or ENDICIA provided by PSI Systems, Inc. of Sunnyvale Calif., adapted to further provide for exposing alternate shipping service provider services according to the concepts herein. Shipping management platform 111 of embodiments may comprise functionality of one or more service environments (e.g., mailing and shipping solutions of STAMPS.COM provided by Stamps.com Inc. of El Segundo Calif.) often not referred to as shipping management, but which nevertheless provide various functions of shipping management (e.g., shipping service selection, generation of shipping labels and postage or other prepaid shipping indicia, tracking of shipment of items through a shipping service provider, etc.).

According to embodiments of the present invention, shipping management platform 111 and carrier support system 112 are operable in cooperation to facilitate exposing alternate shipping service provider services by the shipping management platform, as described in further detail below. For example, cooperative operation with respect to shipping management platform 111 and carrier support system 112 may facilitate access to shipping services offered by alternate shipping service providers (e.g., shipping consolidators or other shipping service providers less-traditionally used in the context of relatively small volume shipping or relatively unsophisticated shippers) to users of shipping management system 100 according to embodiments of the invention.

Carrier support system 112 may comprise one or more processor-based systems (e.g., web servers and/or other computer equipment as may comprise one or more processors, such as a CORE or PENTIUM processor; requisite computer/processor readable memory, such as RAM, ROM, flash memory, disk memory, SSD memory, optical memory, and/or the like; and input/output components, such as display, NIC, keyboard, digital pointer, printer, and/or the like; coupled to a processor of the one or more processors via a data bus) operable to provide integration of carrier support logic with shipping management platform 111. Integration of carrier support logic of carrier support system 112 with shipping management platform 111 according to embodiments of the invention facilitates presenting a carrier presence for one or more shipping service providers, such as shipping service providers (“alternate shipping service providers”) less-traditionally used in the context of relatively small volume shipping or relatively unsophisticated shippers. Carrier support system 112 of embodiments may, for example, comprise shipping logistics functionality of one or more service environments providing carrier logistics management, such as GLOBALPOST carrier logistics service provided by Stamps.com Inc. of El Segundo Calif., configured according to concepts herein to implement carrier support logic providing alternate shipping service provider services exposure in the shipping management system.

Alternate shipping service providers may, for example, include shipping service providers such as local and regional couriers, trucking companies providing TL services and/or LTL/LCL services (e.g., J.B. Hunt, ABF, YRC Freight, etc.), and/or the like. As a further example, alternate shipping service providers may include shipping consolidators (also known as postal consolidators, freight consolidators, or PQWs), such as RRD, IBC, APC Postal Logistics, and/or the like. Such alternate shipping service providers often offer shipping services outside of the mainstream retail shipping services market (e.g., may not be readily available to or accessible by less sophisticated shippers) and/or often do not provide full retail end user shipping services (e.g., end to end conventional shipping services, home delivery or delivery to other than a loading dock, etc.). alternate shipping service providers, such as shipping consolidators often do not have computer platforms supporting large volume shippers and/or often are not readily accessible to individual or small shippers, and often even mid-sized shippers.

Carrier support system 112 of embodiments may comprise carrier support logic configured to operate in cooperation with shipping management platform 111 for providing carrier presences within shipping management system 100 with respect to one or more alternate shipping service providers. Carrier support logic of carrier support system 112 may, for example, provide configured alternate carrier components operable in cooperation with shipping management platform 111 for exposing corresponding alternate shipping service providers for selection and use by various users (e.g., shippers, recipients, etc.) of shipping management system 100. For example, as described further below, a generic alternate carrier component of carrier support system 112 may be used in providing configured alternate carrier components for corresponding alternate shipping service providers. Accordingly, in operation of shipping management platform 111, an alternate shipping service provider may be exposed as a carrier option available to users through the shipping management platform. A generic alternate carrier component, and thus an instances of a configured alternate carrier component configured therefrom, may comprise logic supporting functionality such as updating one or more marketplaces via the shipping management platform with information regarding shipping activity, integration with back office systems (e.g., ERP systems), etc. Accordingly, users of shipping management system 100 may access, query, update, utilize, or otherwise interact with shipping service offerings supported by a respective alternate shipping service provider via a user interface or other portal provided by shipping management platform 111 by cooperative operation of the shipping management platform and carrier support system 112 of embodiments.

Carrier support system 112 of embodiments may interface with and utilize one or more systems, platforms, and/or devices of shipping management system 100 in addition to shipping management platform 111. For example, various functionality supported by carrier support system 112 may be provided through the carrier support logic interfacing with one or more applications, systems (e.g., shipping service provider system 113, postage system 114, electronic marketplace system 115, etc.), devices, etc. (e.g., storage 116) in addition to shipping management platform 111.

Shipping service provider system 113 may comprise one or more processor-based systems (e.g., web servers and/or other computer equipment as may comprise one or more processors, such as a CORE or PENTIUM processor; requisite computer/processor readable memory, such as RAM, ROM, flash memory, disk memory, SSD memory, optical memory, and/or the like; and input/output components, such as display, NIC, keyboard, digital pointer, printer, and/or the like; coupled to a processor of the one or more processors via a data bus) operable to provide functionality with respect to shipping services provided by a shipping service provider. For example, shipping service provider system 113 may comprise one or more server associated with a traditional shipping service provider, such as shipping service providers (“principal shipping service providers”) traditionally used in the context of relatively small volume shipping or relatively unsophisticated shippers. Shipping service provider system 113 of embodiments provides an interface for accessing information and/or rules with respect to services of one or more respective principal shipping service providers, one or more rate charts for the shipping services of the one or more principal shipping service providers, tracking data with respect to shipments made via the one or more shipping service providers, etc.

Principal shipping service providers may, for example, include shipping service providers such as the USPS, UPS, FedEx, DHL, etc. Such principal shipping service providers typically offer a number of end to end conventional shipping services, and are often selected by shippers (e.g., individual, small, and mid-sized shippers) due to their availability and relatively simple shipping services selections. For example, the shipping services platforms served by a shipping service provider system (e.g., shipping service provider system 113) of a principal shipping service provider typically provides readily available and intuitive user interfaces (e.g., via direct shipping service provider portal access) and/or facilitates exposure of the principal shipping service provider in shipping management systems. In operation according to embodiments, various individuals (shippers, intended recipients, etc.) and/or other entities (e.g., businesses, merchants, etc.) may access or otherwise utilize information of shipping service provider system 113 via shipping management platform 111 and/or carrier support system 112.

Postage system 114 may comprise one or more processor-based systems (e.g., web servers and/or other computer equipment as may comprise one or more processors, such as a CORE or PENTIUM processor; requisite computer/processor readable memory, such as RAM, ROM, flash memory, disk memory, SSD memory, optical memory, and/or the like; and input/output components, such as display, NIC, keyboard, digital pointer, printer, and/or the like; coupled to a processor of the one or more processors via a data bus) operable to provide prepaid postage account and postage indicia generation services (e.g., to generate postage indicia, shipping labels, etc. acceptable by the USPS and/or other shipping service providers). For example, postage system 114 may comprise one or more server of the online postage service offered by Stamps.com Inc. Various individuals (shippers, purchasers, etc.) and/or other entities (e.g., business entities, merchants, etc.) may maintain an account with respect to postage system 114 facilitating the generation of postage indicia, whether individually, in batch, in combination with other documentation (e.g., shipping labels, bills of lading, manifests, customs documents, etc.), and whether directly by the account holder or indirectly, such by operation of shipping management platform 111. Prepaid value associated with such accounts may be stored by, or in association with, postage system 114, such as within a postage security device (PSD). Additional or alternative information may be stored by, or in association with, postage system 114, such as user credentials utilized in validating users for account access, usage logs for accounting and/or fraud prevention/detection, rating information for use in shipping service rate determinations, etc. In operation according to embodiments, various individuals (shippers, intended recipients, etc.) and/or other entities (e.g., businesses, merchants, etc.) may access or otherwise utilize information of postage system 114 via shipping management platform 111 and/or carrier support system 112.

Electronic marketplace system 115 may comprise one or more processor-based systems (e.g., web servers and/or other computer equipment as may comprise one or more processors, such as a CORE or PENTIUM processor; requisite computer/processor readable memory, such as RAM, ROM, flash memory, disk memory, SSD memory, optical memory, and/or the like; and input/output components, such as display, NIC, keyboard, digital pointer, printer, and/or the like; coupled to a processor of the one or more processors via a data bus) operable to host platforms for the sale of items, whether items supplied by the electronic marketplace operator themselves, other merchants offering their items for sale through the electronic marketplace, individuals offering items for sale through the electronic marketplace, etc. Electronic marketplace system 115 may, for example, host one or more electronic market places for of electronic marketplace operators, such as eBay, Amazon Marketplace, Shopify, BigCommerce, Etsy, Magento Commerce, etc. In operation according to embodiments, various individuals (shippers, intended recipients, etc.) and/or other entities (e.g., businesses, merchants, etc.) may access or otherwise utilize information of electronic marketplace system 115 via shipping management platform 111 and/or carrier support system 112.

Functionality in addition to or in the alternative to the aforementioned functionality provided by shipping service provider system 113, postage system 114, and/or electronic marketplace system 115 may be provided in or with respect to the environment of shipping management system 100, according to embodiments. For example, functionality may be provided by one or more servers (e.g., manufacturers'systems, distributors'systems, product database systems, etc.) to provide information relevant to shipping various items (e.g., weight information used to determine shipping service rates, item content information used to determine shipping services available for use with respect to particular items, such as in the case of hazardous materials, package size information used to determine shipping service rates and/or compatibility with respect to particular items, customs information, etc.).

Storage 116 shown in the illustrated embodiment disposed in the cloud environment of network 110 may, for example, comprise various forms of tangible, non-transitory computer readable media. For example, storage 116 of embodiments may comprise RAM, ROM, flash memory, disk memory, magnetic memory, SSD memory, optical memory, etc. Storage 116 may comprise a storage array or other storage system, such as a redundant array of independent disks (RAID) array, a storage area network (SAN), a network attached storage (NAS) array, and/or the like. Such computer readable storage may be utilized to store various information, including program code of shipping management platform 111, program code of client applications utilized with respect to shipping management platform 111, carrier support system 112, shipping service provider system 113, postage system 114, and/or electronic marketplace 115, data utilized by and/or with any or all of shipping management platform 111, carrier support system 112, shipping service provider system 113, postage system 114, electronic marketplace system 115, and their client applications, etc. Portions of storage 116 may comprise a part of one or more systems of the cloud (e.g., shipping management platform 111, carrier support system 112, shipping service provider system 113, postage system 114, and/or electronic marketplace system 115) and/or may be separate from such systems (e.g., provided as an independent database system).

User systems 120A-120D of embodiments comprise processor-based systems operable under control of one or more instruction set (e.g., software, firmware, applet, etc.) adapted to interface with various platforms and systems of shipping management system 100 for providing at least some portion of functionality available through the shipping management system. User systems 120A-120D may, for example, comprise one or more servers and/or terminals in the form of one or more computer, workstation, kiosk terminal, portable processor-based device, tablet device, personal digital assistant (PDA), smartphone, etc. Such processor-based systems may comprise a central processing unit (CPU) (e.g., a processor from the PENTIUM or CORE line of processors available from Intel Corporation), memory (e.g., RAM, ROM, flash memory, disk memory, optical memory, etc.) storing the aforementioned one or more instruction set and/or other data used herein, and appropriate input/output circuitry and devices (e.g., network interface card (NIC), keyboard, digital pointer, display screen, peripheral interface, microphone, speaker, wireless interface, etc.). It should be appreciated that, although the illustrated embodiment shows a representative example of the number and configuration of user systems as may be utilized with respect to system 100, the concepts of the present invention are not limited to application to the particular number or configuration of user systems shown.

User system 120A of embodiments may comprise an example of a user device configured for use by an alternate shipping service provider, system operator, or other administrator with respect to one or more platforms and/or systems of shipping management system 100. For example, a user of user system 120A may interact with carrier support system 112 (e.g., directly or via a user interface or other portal of shipping management platform 111) to configure, manage, update, etc. one or more configured alternate carrier components for a respective alternate shipping service provider (e.g., using an instance of a generic alternate carrier component). Such a user may, for example, utilize user system 120A to select one or more carriers as supported by the alternate shipping service provider, designate one or more carrier shipping services as supported by the alternate shipping service provider, provide alternate shipping service provider account details corresponding to the supported carrier shipping services, provide alternate shipping service provider services rules for implementation of the supported carrier shipping services, and/or the like to configure an instance of a generic alternate carrier component for the alternate shipping service provider. A user of user system 120A may additionally or alternatively interact with shipping management platform 111 to interface the one or more configured alternate carrier components with the shipping management platform and enable exposure of the respective alternate shipping service provider as a carrier option available to users via the shipping management platform. User system 120A may include one or more computing resources, such as computing resource 130A (e.g., a printer for printing configuration information, reports, rate charts, etc.), utilized in facilitating such functionality. Of course, additional or alternative forms of computing resources (e.g., scanner, camera, card reader, etc.) may be utilized by user system 120A of some embodiments.

User system 120B may comprise an example of a user device configured for use by a merchant or other shipper to operate with electronic marketplace system 115 of the cloud environment to offer items for sale. A user of user system 120B may additionally or alternatively interact with shipping management platform 111 for managing orders of such items, outbound shipments of the items of such orders, and return of items by purchasers or other recipients thereof. When managing outbound shipments and/or return of items, the user may utilize user system 120B to select a shipping service provider from a plurality of shipping service providers exposed to the user, and available via shipping management platform 111, for providing shipping services. Additionally, the user may utilize user system 120B to select a particular shipping service of the shipping service provider for the shipment. User system 120B may include one or more computing resources, such as computing resources 130A, 130C, and 130D (e.g., a printer for printing shipping labels, manifests, invoices, reports, rate charts, etc., a scale for weighing items to be shipped, a scanner for optically inputting item information, shipping information, etc.), as may be utilized in facilitating such functionality. Of course, additional or alternative forms of computing resources (e.g., camera, card reader, etc.) may be utilized by user system 120B of some embodiments.

User systems 120C and 120D may comprise examples of user devices configured for use by a purchaser or other acquirer/recipient of an item to operate with an electronic commerce or marketplace system of the cloud environment to purchase items. A user of user system 120C or 120D may additionally or alternatively interact with shipping management platform 111 to manage or monitor shipment of orders of purchased items, request and process return shipment of various purchased items, etc. According to some examples, when managing shipment of an order, a user of one of user systems 120C or 120D may utilize the user device to select a shipping service provider and/or shipping service for the item shipment or return. When monitoring shipment of an order, a user of one or user systems 120C or 120D may, for example, utilize the user device to obtain tracking information and/or other information regarding the item shipment. Although not shown in the illustrated example, user systems 120C and/or 120D may include one or more computing resources (e.g., a printer for printing shipping labels, invoices, reports, etc., a scale for weighing items to be shipped, a scanner for optically inputting item information, shipping information, etc.), as may be utilized in facilitating such functionality. Of course, additional or alternative forms of computing resources (e.g., camera, card reader, etc.) may be utilized by either or both of user systems 120C and 120D of some embodiments.

Consistent with the foregoing, user systems 120 (e.g., any of all of user systems 120A-120D) of shipping management system 100 of embodiments comprise one or more client applications, such as for interacting with shipping management platform 111 and/or carrier support system 112 to provide operation as described herein. For example, user systems 120 may comprise a user interface client application operable to facilitate user interaction with shipping management platform 111 and/or carrier support system 112. Such user interface client applications may comprise a web browser (e.g., INTERNET EXPLORER, GOOGLE CHROME, or FIREFOX) hosting a client applet associated with the corresponding platform or system and operable within the web browser. Thus, a user may interact with platforms and systems of shipping management system 100 via a client applet executing within a user interface client application. Additionally or alternatively, user systems 120 may comprise one or more other applications for facilitating operation as described herein. For example, user systems 120 may comprise a mail client (e.g., OUTLOOK, POSTBOX, etc.), a short message service (SMS) client, a social media client (e.g., FACEBOOK, TWITTER, etc.), and/or the like for receiving messages relevant to operations herein. For example, messages delivered using such client applications may comprise shipment notifications, return authorizations, tracking status reports, etc. The messages may include active components operable to cause the user system to interact with functionality of other systems, such as shipping management platform 111 and/or carrier support system 112, such as to request tracking information, request return authorization, generate and print return shipping labels, etc.

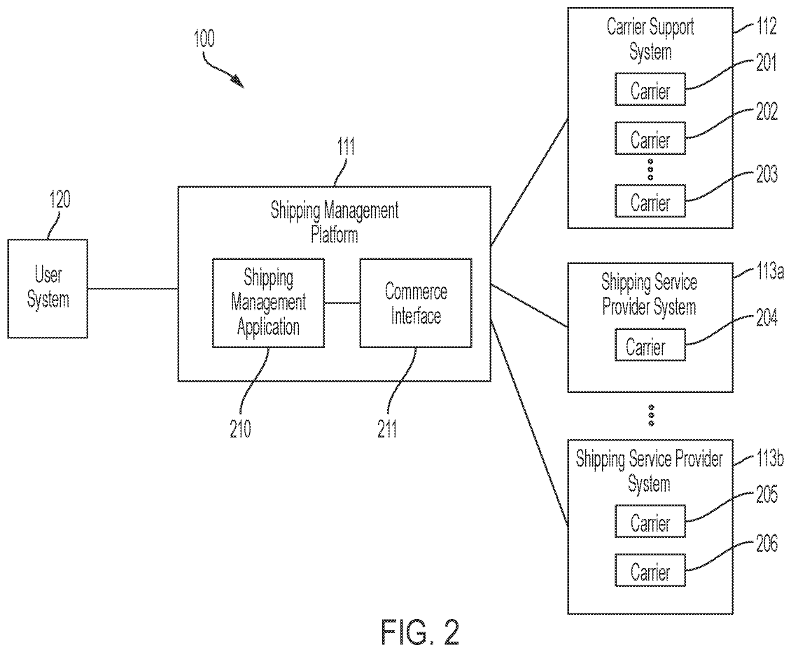

FIG. 2 shows a functional block diagram of a portion of shipping management system 100 of embodiments of the present invention. As shown in FIG. 2, user system 120 (e.g., any of user systems 120A-120D) is in communication with shipping management platform 111 for performing various shipping management and/or related tasks. For example, one or more users (e.g., shippers, purchasers or other recipients, etc.) may initiate, control, and/or receive shipping management services of shipping management platform 111 via user system 120.

Shipping management platform 111 of the example of FIG. 2 comprises shipping management application 210, such as may comprise processor executable instructions (e.g., software, code, logic, etc.) and associated data for performing shipping management functionality. The shipping management functionality may, for example, include selecting a shipping service provider and particular shipping services for the shipment of an item, generating associated shipping documentation (e.g., postage indicia, shipping labels, bills of lading, manifests, customs documents, etc.) acceptable by or in compliance with the shipping service provider, obtaining tracking information with respect to shipment of items by the shipping service provider, etc.

Carrier support system 112 and shipping service provider systems 113a and 113b are shown in the embodiment illustrated in FIG. 2 in communication with shipping management platform 111. Carrier support system 112 may provide or otherwise facilitate the aforementioned shipping management functionality with respect to one or more alternate shipping service providers. For example, carrier support system 112 may provide one or more carrier presences for the alternate shipping service providers through which services and information with respect to services provided by the corresponding alternate shipping service providers may be accessed. In an example, carrier presences 201 and 202 may be provided with respect to a first alternate shipping service provider (e.g., for first and second induction locations of the first alternate shipping service provider, such as RRD, IBC, or APC Postal Logistics) and carrier presence 203 may be provided with respect to a second alternate shipping service provider (e.g., a different one of RRD, IBC, or APC Postal Logistics). Shipping service provider systems 113a and 113b may, for example, comprise instances of shipping service provider system 113 of FIG. 1 corresponding to respective principal shipping service providers. Accordingly, shipping service provider systems 113a and 113b may provide or otherwise facilitate the aforementioned shipping management functionality with respect to a respective principal shipping service provider. For example, shipping service provider systems 113a and 113b may each provide one or more carrier presences for the respective principal shipping service providers through which services and information with respect to services provided by the respective principal shipping service providers may be accessed. In an example, carrier presence 204 may be provided with respect to a first principal shipping service provider (e.g., USPS, UPS, or FedEx) and carrier presences 205 and 206 may be provided with respect to a second principal shipping service provider (e.g., for first and second shipping segment entities of the second principal shipping service provider, such as DHL Express and DHL eCom).

Shipping management platform 111 of the embodiment of FIG. 2 includes commerce interface 211, such as may be utilized to interface with and/or otherwise interact with various systems and platforms (e.g., carrier support system 112, shipping service provider system 113, etc.) of shipping management system 100. Commerce interface 211 of embodiments may comprise one or more APIs, gateways, or other intermediaries configured to provide data exchange and/or interoperability by and between shipping management platform 111, carrier support system 112, shipping service provider system 113, etc. Commerce interface 211 of embodiments may, for example, comprise an iPaaS system (e.g., commerce API solutions of SHIPENGINE provided by Auctane LLC of Austin Tex.). It should be appreciated that, although commerce interface 211 is shown integral to shipping management platform 111, shipping management platform 111 and commerce interface 211, or portions thereof, may be implemented separately (e.g., hosted by different server systems within shipping management system 100) according to embodiments of the invention.

In operation according to embodiments, shipping management platform 111 is interoperable with carrier support system 112 and shipping service provider systems 113a and 113b to facilitate access to various functionality for the provided carrier presences in association with use of shipping management application 210. For example, shipping management application 210 may access one or more of carrier presences 201-206 via commerce interface 211 in association with performing shipping management services on behalf of a user of user system 120. The shipping services and other aspects of the respective shipping service providers (e.g., principal shipping service providers and alternate shipping service providers) may thus be exposed by shipping management platform 111 and made available to users (e.g., shippers, purchasers or other recipients, etc.) of shipping management system 100, such as for selection of a shipping service provider, shipping service selection, generation of shipping labels and postage or other prepaid shipping indicia, tracking of shipment of items through a shipping service provider, etc. Accordingly, alternate shipping service provider services (e.g., shipping services offered at reduced rates, robust shipping services or shipping services tailored for particular needs, etc.) may be exposed in the shipping management system similar or equal to that of the exposure of principal shipping service providers within the shipping management system.

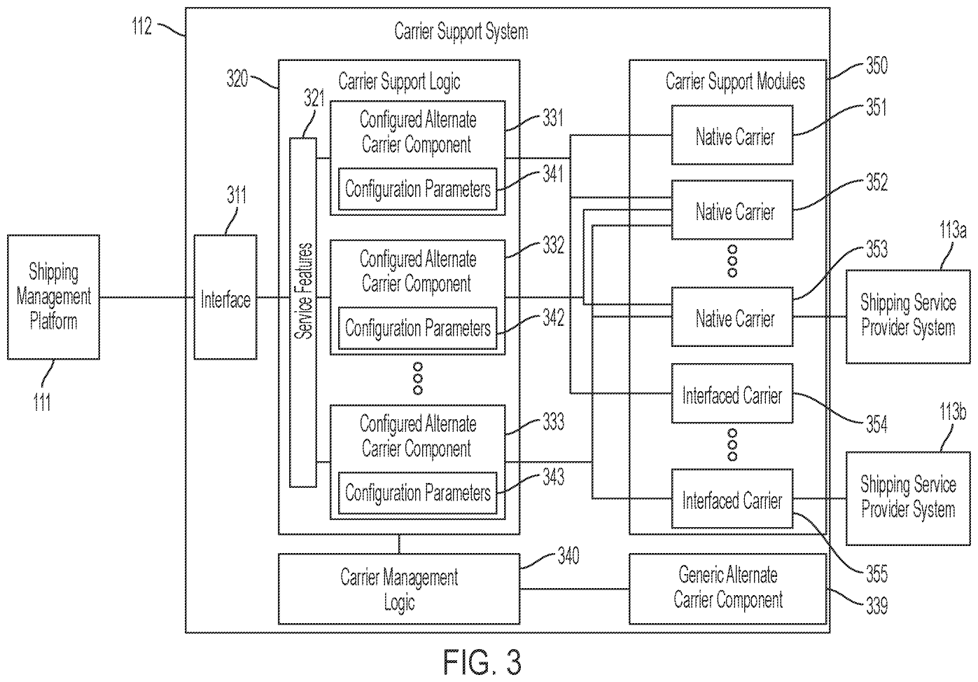

FIG. 3 shows a functional block diagram providing further detail with respect to an embodiment of carrier support system 112. Carrier support system 112 of the example of FIG. 3 includes interface 311, carrier support logic 320, generic carrier alternate carrier component 339, carrier management logic 340, and carrier support modules 350 utilized according to concepts herein for exposing various alternate shipping service provider services in shipping management system 100.

Interface 311 of embodiments may comprise one or more APIs, gateways, or other intermediaries configured to provide data exchange and/or interoperability by and between shipping management platform 111, carrier support system 112, shipping service provider system 113, etc. For example, interface 311 may operate in cooperation with commerce interface 211 (FIG. 2) for facilitating interoperability with respect to shipping management platform 111 and carrier support system 112. According to some embodiments, interface 311 may implement one or more APIs operable according to the HL7 standards (HAPI) for interfacing with commerce interface 211. Although not specifically shown in FIG. 3, interface 311, or one or more additional instances of such an interface, may be utilized for providing data exchange and/or interoperability by and between carrier support modules of carrier support modules 350 and corresponding ones of the shipping service provider systems (e.g., shipping service provider systems 113a and 113b).

Carrier support logic 320 of embodiments of carrier support system 112 comprises processor implemented logic (e.g., processor executable instructions, software, code, logic objects, etc. and associated data) operable to establish and host one or more carrier presences and facilitate various functionality thereof. For example, carrier support logic 320 may utilize service features frontend 321 (e.g., software) serving or otherwise providing a feature set for accessing services and functionality of one or more carrier presences hosted by the carrier support system. Service features frontend 321 may, for example, provide a number of default service options (e.g., access control, mapping of user credentials to a corresponding carrier presence, communication and messaging support, etc.) in combination with service options of a particular carrier presence being accessed by shipping management platform 111 (e.g., shipping services supported by a particular carrier, rating information for the particular carrier, tracking and/or other reporting supported by the particular carrier, etc.). Configured alternate carrier components 331-333 (e.g., logic constructs), configured for respective alternate shipping service providers, may be utilized by carrier support logic 320 of embodiments to provide corresponding instances of carrier presences (e.g., corresponding ones of carrier presences 201-203 of FIG. 2) facilitating respective service options. Configured alternate carrier components 331-333 of embodiments, for example, comprise various configuration parameters (e.g., configuration parameters 341-343) used in establishing service options of a particular carrier presence and their corresponding behavior, as accessible by shipping management platform 111. The configuration parameters of embodiments may include information with respect to shipping service providers utilized by the respective alternate shipping service provider, shipping services supported by the respective alternate shipping service provider, alternate shipping service provider account details corresponding to the supported carrier shipping services, rules for implementation of the supported carrier shipping services supported by the alternate shipping service provider, etc., tailoring the configured alternate carrier component for a carrier presence representative of the respective alternate shipping service provider. As shown in the example of FIG. 3, carrier support system 112 may provide aspects of configured alternate carrier components 331-333, and the service options associated therewith, for a corresponding shipping service provider to shipping management platform 111 via service features frontend 321 facilitating accessing, querying, updating, utilizing, or otherwise interacting with shipping service offerings supported by a respective alternate shipping service provider via the shipping management platform.

Carrier support modules 350 of embodiments link services logic for a corresponding shipping service provider (e.g., principal shipping service providers) with one or more carrier presences hosted by carrier support system 112 for facilitating various shipping service offerings supported by a respective alternate shipping service provider. Carrier support modules 350 of embodiments comprise various logic (processor executable instructions, software, code, logic objects, logic constructs, etc. and associated data) for facilitating carrier shipping services supported by an alternate shipping service provider. Individual carrier support modules (e.g., carrier support modules 351-355) of carrier support modules may correspond to one or more particular shipping service providers to facilitate carrier shipping services of that shipping service provider as supported by an alternate shipping service provider. For example, carrier support module 351 may facilitate carrier shipping services of a first shipping service provider as supported by one or more alternate shipping service providers for which carrier presences are hosted by carrier support system 112, carrier support module 352 may facilitate carrier shipping services of a second shipping service provider as supported by one or more alternate shipping service providers for which carrier presences are hosted by carrier support system 112, and so on.

Carrier support modules 350 may, for example, comprise information with respect to the particular shipping services and related services offered by a corresponding shipping service provider, information with respect to various functionality for the shipping service provider (e.g., rating, routing, tracking, etc.) and/or for invoking select functionality. According to some examples, carrier support modules 350 may comprise compliance information and/or rules for shipping services (e.g., information for generation of compliant labels, shipped item contents, weight, and/or size eligible for particular shipping services, routes, etc., conditions for use of particular shipping services, etc.).

It should be appreciated that, in the example of FIG. 3, carrier support modules 350 include instances of differently implemented carrier support modules. In particular, carrier support modules 350 include native carrier support modules 351-353 and interfaced carrier support modules 354 and 355. Native carrier support modules 351-353 may each comprise logic for performing functionality of various shipping service offerings supported by a respective alternate shipping service provider. For example, each of native carrier support modules 351-353 may include a set of services that are selectable by an alternate shipping service provider for offering through the shipping management system as the supported carrier shipping services supported by the alternate shipping service provider. Further, native carrier support modules 351-353 may include logic to provide rating based off of alternate shipping service provider rate charts for the corresponding shipping service provider, routing based off of alternate shipping service provider services rules, logic to provide tracking based off of alternate shipping service provider services rules, logic to support compliance with shipping rules of the corresponding shipping service provider, logic to support labeling, rating, and manifesting with respect to the corresponding carrier, etc. In contrast, interfaced carrier support modules 354 and 355 may each comprise logic for interfacing externally with carrier support logic for performing functionality of various shipping service offerings supported by a respective alternate shipping service provider. For example, a particular shipping service provider and/or shipping services supported by an alternate shipping service provider may implement (e.g., using a respective one of shipping service provider systems 113a and 113b) logic to provide rating based off of alternate shipping service provider rate charts for the corresponding shipping service provider, routing based off of alternate shipping service provider services rules, logic to provide tracking based off of alternate shipping service provider services rules, logic to support compliance with shipping rules of the corresponding shipping service provider, logic to support labeling, rating, and manifesting with respect to the corresponding carrier, etc., which is accessible via a respective interfaced carrier support module.

Irrespective of the particular implementation (e.g., native or interfaced), carrier support modules 350 of embodiments provide a set of services that are selectable by an alternate shipping service provider for offering through the shipping management system. Accordingly, in operation according to some embodiments, a configured alternate carrier component may interface the carrier shipping services supported by a corresponding alternate shipping service provider with the shipping management platform in a carrier presence option exposed for the alternate shipping service provider.

In some examples, an alternate shipping service provider for which a configured alternate carrier component is configured, and correspondingly a carrier presence is establish in carrier support system 112, may comprise a shipping consolidator, such as may utilize the services of other shipping service providers (e.g., one or more principal shipping service providers, other alternate shipping service providers, additional services providers, etc.) to provide shipping services and/or services related thereto. Accordingly, a configured alternate carrier component may interface carrier shipping services for each such shipping service provider supported by a corresponding alternate shipping service provider. In the example, of FIG. 3, configured alternate carrier component 331 interfaces carrier shipping services for shipping service providers corresponding to native carrier support modules 351 and 351 and interfaced carrier support module 354 for a corresponding alternate shipping service provider (e.g., a first alternate shipping service provider), configured alternate carrier component 332 interfaces carrier shipping services for shipping service providers corresponding to native carrier support modules 352 and 353 for a corresponding alternate shipping service provider (e.g., the first alternate shipping service provider or a second alternate shipping service provider), and configured alternate carrier component 333 interfaces carrier shipping services for shipping service providers corresponding to native carrier support modules 352 and 353 and interfaced carrier support module 355 for a corresponding alternate shipping service provider (e.g., the first alternate shipping service provider, the second alternate shipping service provider, or a third alternate shipping service provider).

A configured alternate carrier component may thus be tailored or otherwise designed for the respective alternate shipping service provider for providing a set of services offered through the shipping management system by or on behalf of the alternate shipping service provider. The example of FIG. 3 includes carrier management logic 340 and generic alternate carrier component 339 as may be used to configure one or more configured alternate carrier components of carrier support logic 320. Generic alternate carrier component 339 of embodiments provides a framework (e.g., software or logic construct) configurable to interface selected carrier shipping services offerings with a shipping management platform of the shipping management system. For example, generic alternate carrier component 339 may comprise logic configurable (e.g., using various configuration parameters establishing service options and their corresponding behavior) for facilitating accessing, querying, updating, utilizing, or otherwise interacting with shipping service offerings supported by a respective alternate shipping service provider via a user interface or other portal provided by the shipping management platform. Generic alternate carrier component 339 of some embodiments may comprise logic configurable to support various additional functionality, such as supporting updating one or more marketplaces via the shipping management platform with information regarding shipping activity, integration with ERP systems and/or other back office systems, etc. Carrier management logic 340 of embodiments of carrier support system 112 comprises processor implemented logic (e.g., processor executable instructions, software, code, logic objects, etc. and associated data) operable to configure an instance of generic alternate carrier component 339 for a first alternate shipping service provider to provide a configured alternate carrier component of carrier support logic 320. Carrier management logic 340 may, for example, provide a management application used for configuring an alternate carrier component, creating their users, adding new carriers and services, uploading rate charts, etc.

In operation according to embodiments of the invention, carrier support system 112 may provide a user interface and associated functionality for configuring an instance of generic alternate carrier component 339 to provide a configured alternate carrier component for a respective alternate shipping service provider. Configuration of the generic alternate carrier component may, for example, include a user interacting with carrier management logic 340 to designate one or more carrier shipping services of a plurality of carrier shipping services as supported carrier shipping services that are supported by the alternate shipping service provider, provide alternate shipping service provider account details corresponding to the supported carrier shipping services, provide alternate shipping service provider services rules for implementation of the supported carrier shipping services as supported by the alternate shipping service provider, select one or more carriers from a plurality of shipping service providers as supported carriers that are supported by the alternate shipping service provider, etc. Carrier management logic 340 may thus obtain and/or generate configuration parameters used in establishing service options of a particular carrier presence for the alternate shipping service provider. Accordingly, a configured alternate carrier component tailored or otherwise designed for the alternate shipping service provider may be provided by operation of carrier management logic 340 with respect to an instance of generic alternate carrier component 339 of embodiments.

Configured alternate carrier components implemented according to embodiments of the invention facilitate altering one or more aspects of the configured alternate carrier component to dynamically change one or more aspects of a set of services offered through the shipping management system by or on behalf of the alternate shipping service provider. For example, a configured alternate carrier component may be altered or otherwise reconfigured to change shipping services supported by an alternate shipping service provider, to change an underlying shipping service provider for one or more services supported by an alternate shipping service provider, etc. In operation according to embodiments, carrier management logic 340 may thus be utilized to alter one or more aspects of a configured alternate carrier component to dynamically change at least one service exposed for the alternate shipping service provider to users through shipping management system 100. As an example, one or more configuration parameters may be altered in order to switch selection of a first carrier support module for selection of a second carrier support module to thereby dynamically change a shipping service provider providing shipping services exposed for the first alternate shipping service provider by the shipping management system (e.g., a shipping service provider that becomes unavailable, such as due to labor strikes, business failure, etc., may readily be replaced with a viable shipping service provider).

Although examples have been described above with reference to configured alternate carrier components and their use in exposing shipping services in shipping management system 100 by or on behalf of an alternate shipping service providers such as shipping consolidators, it should be appreciated that concepts herein are applicable with respect to exposing shipping services of other shipping service providers. For example, an instance of a generic alternate carrier component may be configured for a principal shipping service provider to provide a configured principal carrier component for exposing shipping services in shipping management system 100 by or on behalf of the principle shipping service provider. Such an embodiment may, for example, be utilized to expose shipping services in shipping management system 100 for a principle shipping service provider which is not otherwise provided direct exposure by shipping management platform 111 (e.g., a principal shipping service provider not having a robust computer platform providing readily available and intuitive user interface facilitating exposure in a shipping management system). As another example, an instance of a generic alternate carrier component may be likewise configured for an alternate shipping service provider other than a shipping consolidator (e.g., an alternate shipping service provider which provides all its own shipping services) to provide a configured alternate carrier component for exposing shipping services in shipping management system 100 by or on behalf of the alternate shipping service provider. Such an embodiment may utilize a carrier support module, and possibly a shipping service provider system, corresponding to the alternate shipping service provider to facilitate carrier shipping services of that alternate shipping service provider.

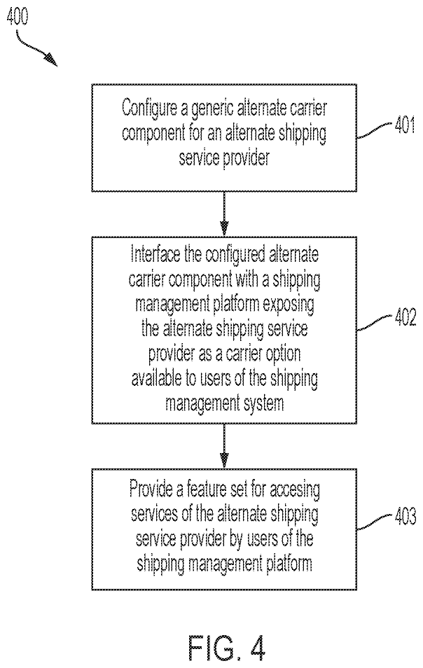

FIG. 4 shows a flow diagram of a process for exposing shipping services of an alternate shipping service provider to users of shipping management system 100 according to embodiments of the invention. In accordance with some examples, the functionality of flow 400 may be performed by or using logic of carrier support system 112 of embodiments.

At block 401 of the illustrated example of flow 400, a generic alternate carrier component is configured for an alternate shipping service provider. For example, carrier management logic 340 may operate to configure a first instance of a generic alternate carrier component 339 for a first alternate shipping service provider to provide a first configured alternate carrier component 331 of carrier support logic 320 in shipping management system 100 for the first alternate shipping service provider. As described above, the generic alternate carrier component of embodiments provides a framework configured to interface selected carrier shipping services offerings with shipping management platform 111. Accordingly, configuring the generic alternate carrier component may include providing information and parameters used in establishing service options of a particular carrier presence and their corresponding behavior for the alternate shipping service provider.

In operation according to some examples, configuring the generic alternate carrier component may include selecting one or more carriers from a plurality of shipping service providers as supported carriers that are supported by the alternate shipping service provider. Where, for example, the alternate shipping service provider is a shipping consolidator, the alternate shipping service provider may utilize one or more services providers (e.g., one or more principal shipping service providers, other alternate shipping service providers, additional services providers, etc.) for proving various services related to the shipment of items. Accordingly, particular shipping service providers of a plurality of shipping service providers that are utilized by or otherwise supported by the alternate shipping service provider may be selected. In accordance with some embodiments, configuring the generic alternate carrier component in association with selecting one or more carriers may configure one or more corresponding carrier support modules to interface services logic for a respective shipping service provider with the shipping management platform via the configured alternate carrier component.

Configuring the generic alternate carrier component may additionally or alternatively include designating one or more carrier shipping services of a plurality of carrier shipping services as supported carrier shipping services that are supported by the alternate shipping service provider. For example, particular shipping services of the shipping services of one or more shipping service provider may be utilized or otherwise supported by the alternate shipping service provider, and thus may be designated so as to be included in a set of services offered by the alternate shipping service provider through the shipping management system.

Additionally or alternatively, configuring the generic alternate carrier component may include providing alternate shipping service provider account details corresponding to the supported carrier shipping services. Information regarding various terms and conditions of the use of the shipping services by the alternate shipping service provider may, for example, be provided for configuring carrier shipping services that are supported by the alternate shipping service provider. As a specific example, the first alternate shipping service provider account details of some embodiments may include one or more rate charts for the supported carrier shipping services (e.g., rates paid by the alternate shipping service provider for the shipping services of another shipping service provider) and/or shipper facing rate information for the first alternate shipping service provider. (e.g., rates paid by the shipping management platform users to alternate shipping service provider for the shipping services). As another example, the first alternate shipping service provider account details may include conditions under which the supported carrier shipping services are utilized by the alternate shipping service provider (e.g., prepaid/post-paid shipping, service limits, shipping services compliance terms, etc.).

Further, configuring the generic alternate carrier component may additionally or alternatively include providing alternate shipping service provider services rules for implementation of the supported carrier shipping services as supported by the alternate shipping service provider. The services rules may, for example, provide information regarding shipping situations in which particular services are to be made available, particulars as to how aspects of particular shipping services are to be offered or performed, etc. As a specific example, the alternate shipping service provider services rules may include routing rules for use of one or more shipping services supported by the alternate shipping service provider. As another example, the alternate shipping service provider services rules may include shipping label generation rules for generating compliant shipping labels for the shipping service provider.

As described above, a number of different configured alternate carrier components may be configured from instances of generic alternate carrier components. Accordingly, configuring of block 401 of flow 400 may be performed to provide a plurality of configured alternate carrier components. Ones of the configured alternate carrier components may be configured for different (e.g., a first and a second) alternate shipping service providers. For example, a first configured alternate carrier component may be configured for the first alternate shipping service provider and a first configured alternate carrier component may be configured for the first alternate shipping service provider. Additionally or alternatively, multiple ones of the configured alternate carrier components may be configured for a same (e.g., first) alternate shipping service provider. For example, a first configured alternate carrier component may be configured for a first induction location of the first alternate shipping service provider (e.g., a first location at which the shipped items are initially processed by the first shipping service provider) and a second configured alternate carrier component may be configured for a second induction location of the first alternate shipping service provider (e.g., a second location at which the shipped items are initially processed by the first shipping service provider).

According to some embodiments of the invention, configuring the generic alternate carrier component may include mapping of user credentials to a corresponding carrier presence established in the carrier support system by a configured alternate carrier component. For example, information regarding user names and passwords of the users associated with the alternate shipping service provider may be provided for mapping particular users to a specific instance of configured alternate carrier components (e.g., users disposed more near a first induction location of the first alternate shipping service provider may be mapped to a first configured alternate carrier component, whereas users disposed more near a second induction location of the first alternate shipping service provider may be mapped to a second configured alternate carrier component). In another example, information regarding user names and passwords of the users may be provided for mapping particular users to particular alternate shipping service providers (e.g., a first set of users may be mapped to a first configured alternate carrier component corresponding to a first alternate shipping service provider and a second set of users may be mapped to a second configured alternate carrier component corresponding to a second alternate shipping service provider, wherein some users may be included in both the first set and the second set).

Continuing with the operation according to flow 400 of FIG. 4, at block 402 of the illustrated example, the configured alternate carrier component(s) are interfaced with shipping management platform 111 exposing the alternate shipping service provider(s) as carrier options available to user of shipping management system 100. For example, one or more of configured alternate carrier components 331-333 may be deployed with respect to carrier support logic 320 for establishing corresponding carrier presences in carrier support system 112, whereby the respective alternate shipping service providers are exposed in the shipping management system as carrier options (e.g., present the alternate shipping service providers as shipping service provider options with respect to one or more principal shipping service providers). According to some examples, configured alternate carrier components 331-333 provide logic constructs that are utilized by logic routines of carrier support logic to establish corresponding instances of carrier presences and facilitate respective service options.

At block 403 of flow 400, one or more feature sets are provided for accessing services of alternate shipping service providers by users of shipping management platform 111. For example, service features frontend 321 may provide a feature set for accessing services and functionality (e.g., selection of a shipping service provider, shipping service selection, generation of rating and/or routing information for item shipments, generation of shipping labels and postage or other prepaid shipping indicia, tracking of shipment of items through a shipping service provider, etc.) of one or more alternate carrier presences corresponding to configured alternate carrier components 331-333 hosted by carrier support system 320. Accordingly, the services and functionality may be made available in a user interface of shipping management platform 111, such as via interface 311, commerce interface 211, and shipping management application 210). Users may, for example, access shipping management platform 111 via a respective one of user devices 120 and as part of the shipping management functionality supported thereby to select an alternate shipping service provider from among a plurality of shipping service providers (e.g., one or more principal shipping service providers, one or more alternate shipping service providers, etc.) for performing services with respect to shipment of an item, select and utilize one or more services of an alternate shipping service provider, interact with various functionality (e.g., tracking, rating, routing, etc.) of an alternate shipping service provider, etc. Moreover, various services and functionality may be provided by carrier support system 112 with respect to other platforms and systems of shipping management system 100 (e.g., electronic marketplaces, accounting application platforms, ERP systems, etc.), such as to provide data to and/or receive data from such platforms and systems regarding shipping activity.

As can be appreciated from the foregoing, implementation of alternate carrier components according to embodiments of the invention facilitates addition of alternate shipping service providers as carrier options of a shipping management system through a configuration process in which various information, such as shipping service provider information, shipping services information, rate data, routing rules, rules for implementation of shipping services, user information, etc. with respect to alternate shipping service providers is provided. Moreover, one or more aspects of a configured alternate carrier component may be altered to change at least one service (e.g., change shipping services supported, change underlying shipping service providers, etc.) exposed for the first alternate shipping service provider to users through the shipping management system. For example, a configured alternate carrier component may be altered to switch selection of a first carrier support module for selection of a second carrier support module to dynamically change a shipping service provider providing shipping services exposed for the first alternate shipping service provider by the shipping management system (e.g., to swap a primary shipping service provider when an initially selected shipping service provider becomes unavailable or undesirable). As another example, a configured alternate carrier component may be altered to add selection of an additional carrier support module for an alternate shipping service provider (e.g., to onboard a new or newly supported principal shipping service provider).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for exposing shipping services of an alternate shipping service provider to users of a shipping management system, the method comprising:
configuring a first instance of a generic alternate carrier component for a first alternate shipping service provider to provide a first configured alternate carrier component of carrier support logic in the shipping management system for the first alternate shipping service provider, wherein the generic alternate carrier component provides a framework configured to interface selected carrier shipping services offerings with a shipping management platform of the shipping management system, wherein the configuring the first instance of the generic alternate carrier component includes:
designating one or more carrier shipping services of a plurality of carrier shipping services as supported carrier shipping services that are supported by the first alternate shipping service provider; and
providing first alternate shipping service provider account details corresponding to the supported carrier shipping services; and
interfacing the first configured alternate carrier component with the shipping management platform to expose the first alternate shipping service provider as a carrier option available to the users of the shipping management system.

2. The method of claim 1, wherein interfacing the first configured alternate carrier component with the shipping management platform configures the shipping management system to present the first alternate shipping service provider as a carrier option with respect to carrier options for one or more principal shipping service providers.

3. The method of claim 2, wherein the one or more principal shipping service providers include one or more shipping service providers selected from the group consisting of the United States Postal Service (USPS), United Parcel Service (UPS), Federal Express (FedEx), and Dalsey, Hillblom, and Lynn (DHL).

4. The method of claim 1, wherein interfacing the first instance of the first configured alternate carrier component with the shipping management platform configures the shipping management system to present the first alternate shipping service provider as a carrier option with respect to carrier options for at least one principal shipping service provider and a second alternate shipping service provider.

5. The method of claim 1, wherein the generic alternate carrier component comprises logic to support updating one or more marketplaces via the shipping management platform with information regarding shipping activity.

6. The method of claim 1, wherein the first alternate shipping service provider account details include one or more rate charts for the supported carrier shipping services and shipper facing rate information for the first alternate shipping service provider.

7. The method of claim 1, wherein the configuring the first instance of the generic alternate carrier component further includes:
providing first alternate shipping service provider services rules for implementation of the supported carrier shipping services as supported by the first alternate shipping service provider.

8. The method of claim 7, wherein the first alternate shipping service provider services rules include routing rules and shipping label generation rules.

9. The method of claim 1, wherein the first alternate shipping service provider comprises a shipping consolidator, and wherein the configuring the first instance of the generic alternate carrier component further includes:
selecting one or more carriers from a plurality of shipping service providers as supported carriers that are supported by the first alternate shipping service provider.

10. The method of claim 9, wherein carrier support modules are provided for each of the plurality of shipping service providers, wherein one or more of the carrier support modules are configured to interface services logic for a corresponding shipping service provider of the plurality of shipping service providers with the shipping management platform via instances of configured alternate carrier components, and wherein the first configured alternate carrier component interfaces the supported carrier shipping services of the supported carriers with the shipping management platform in the carrier option exposed for the first alternate shipping service provider.

11. The method of claim 10, wherein the carrier support modules comprise a set of services that are selectable by the first alternate shipping service provider for offering through the shipping management system as the supported carrier shipping services supported by the first alternate shipping service provider.

12. The method of claim 11, wherein the carrier support modules comprise logic to provide routing based off of first alternate shipping service provider services rules.

13. The method of claim 11, wherein the carrier support modules comprise logic to provide tracking based off of first alternate shipping service provider services rules.

14. The method of claim 11, wherein the carrier support modules comprise logic to support compliance with shipping rules of the corresponding shipping service provider.

15. The method of claim 11, wherein the carrier support modules comprise logic to support labeling, rating, and manifesting with respect to the corresponding carrier.

16. The method of claim 10, wherein the carrier support modules include one or more native carrier support modules providing, internally with respect to the carrier support logic, label rules, rating algorithms, and routing rules of the services logic of the corresponding shipping service provider.

17. The method of claim 16, wherein the carrier support modules include one or more interfaced carrier support modules providing, externally with respect to the carrier support logic via an interface, label rules, rating algorithms, and routing rules of the services logic of the corresponding shipping service provider.

18. The method of claim 1, further comprising:
configuring a second instance of the generic alternate carrier component for the first alternate shipping service provider to provide a second configured alternate carrier component of the carrier support logic in the shipping management system for the first alternate shipping service provider; and
interfacing the second configured alternate carrier component with the shipping management platform to further expose the first alternate shipping service provider as a carrier option available to the users of the shipping management system, wherein the first configured alternate carrier component is exposed by the shipping management platform for transactions corresponding to a first induction location of the first alternate shipping service provider and the second configured alternate carrier component is exposed by the shipping management platform for transactions corresponding to a second induction location of the first alternate shipping service provider.

19. The method of claim 18, further comprising:
configuring a third instance of the generic alternate carrier component for a second alternate shipping service provider to provide a third configured alternate carrier component for the second alternate shipping service provider; and
interfacing the third configured alternate carrier component with the shipping management platform to expose the second alternate shipping service provider as another carrier option available to the users of the shipping management system.

20. The method of claim 18, wherein a user name and password of the users map to a specific instance of the first and second configured alternate carrier components.

21. The method of claim 1, further comprising:
altering one or more aspects of the first configured alternate carrier component to dynamically change at least one service exposed for the first alternate shipping service provider to users through the shipping management system.

22. The method of claim 21, wherein altering the one or more aspect of the first configured alternate carrier component comprises:
switching selection of a first carrier support module for selection of a second carrier support module to dynamically change a shipping service provider providing shipping services exposed for the first alternate shipping service provider by the shipping management system.

23. A system for exposing shipping services of an alternate shipping service provider as a carrier option with respect to carrier options for one or more principal shipping service providers, the system comprising:
a generic alternate carrier component providing a configurable framework to interface selected carrier shipping services offerings with a shipping management application of a shipping management system;
a plurality of carrier support modules having services logic with respect to shipping services offered by a corresponding shipping service provider; and
carrier support logic hosting a first carrier presence presenting service options for a first alternate shipping service provider and operable to interoperate with the shipping management application of the shipping management system to present the first alternate shipping service provider as a carrier option in the shipping management application, wherein the carrier support logic includes:
a first configured alternate carrier component for the first alternate shipping service provider, wherein the first configured alternate carrier component comprises an instance of the generic alternate carrier component including one or more configuration parameters for the first alternate shipping service provider and links the first carrier presence for the first alternate shipping service provider to the services logic of a respective carrier support module for one or more selected shipping service provider.

24. The system of claim 23, further comprising:
carrier management logic providing a management application for configuring the first configured alternate carrier component from the instance of the generic alternate carrier component.

25. The system of claim 23, wherein the plurality of carrier support modules comprise:
a native carrier support module including a set of services that are selectable by the alternate shipping service provider for offering through the shipping management system as supported carrier shipping services supported by the alternate shipping service provider; and
an interfaced carrier support module including logic for interfacing externally with carrier support logic for shipping service offerings supported by the alternate shipping service provider.

26. The system of claim 23, wherein a carrier support module of the plurality of carrier support modules comprises:
information with respect to rating, routing, or tracking functionality for the corresponding shipping service provider.

27. The system of claim 23, wherein a carrier support module of the plurality of carrier support modules comprises:
compliance information for the corresponding shipping service provider.

28. The system of claim 23, wherein the carrier support logic includes:
a plurality of configured alternate carrier components, wherein each configured alternate carrier component of the plurality of configured alternate carrier components comprises an instance of the generic alternate carrier component including one or more configuration parameters for a corresponding alternate shipping service provider.

29. The system of claim 28, wherein the carrier support logic hosts a second carrier presence presenting service options for the first alternate shipping service provider, and wherein a second configured alternate carrier component of the plurality of configured alternate carrier components is configured for the first alternate shipping service provider and comprises an instance of the generic alternate carrier component including one or more configuration parameters for the first alternate shipping service provider and links the second carrier presence for the first alternate shipping service provider to the services logic of a respective carrier support module for one or more selected shipping service provider.

30. The system of claim 29, wherein the first and second configured alternate carrier components are configured for two different locations of the first alternate shipping service provider.

31. The system of claim 28, wherein the carrier support logic hosts a second carrier presence presenting service options for a second alternate shipping service provider, and wherein a second configured alternate carrier component of the plurality of configured alternate carrier components is configured for the second alternate shipping service provider and comprises an instance of the generic alternate carrier component including one or more configuration parameters for the second alternate shipping service provider and links the second carrier presence for the second alternate shipping service provider to the services logic of a respective carrier support module for one or more selected shipping service provider.

32. A method for exposing shipping consolidator services to users of a shipping management system, the method comprising:
configuring a first instance of a generic consolidator carrier component for a first shipping consolidator to provide a first consolidator carrier component of carrier support logic in the shipping management system for the first shipping consolidator, wherein the generic consolidator carrier component provides a framework configured to interface selected carrier shipping services offerings from carrier support modules of a carrier library with the shipping management platform, wherein the configuring the first instance of the generic consolidator carrier module includes:
selecting one or more shipping service providers as selected carriers supported by the first shipping consolidator;
designating one or more carrier shipping services of the carrier support modules for each of the selected carriers as supported carrier shipping services that are supported by the first shipping consolidator; and
providing first shipping consolidator account details for each of the one or more selected carriers; and
interfacing the first consolidator carrier component with the shipping management platform to expose the first shipping consolidator as a carrier option available to the users of the shipping management system.

33. The method of claim 32, wherein interfacing the first consolidator carrier component with the shipping management platform configures the shipping management system to present the first shipping consolidator as a carrier option with respect to carrier options for one or more principal shipping service providers.

34. The method of claim 32, wherein interfacing the first consolidator carrier component with the shipping management platform configures the shipping management system to present the first shipping consolidator as a carrier option with respect to carrier options for at least one principal shipping service provider and a second shipping consolidator.

35. The method of claim 32, wherein the generic consolidator carrier component comprises logic to support updating one or more marketplaces via the shipping management platform with information regarding shipping activity.

36. The method of claim 32, wherein the first shipping consolidator account details include a rate chart for each of the selected carriers and shipper facing rate information for the first shipping consolidator.

37. The method of claim 32 wherein the configuring the first instance of the generic consolidator carrier component further includes:
providing first shipping consolidator services rules for implementation of one or more carrier shipping services of the supported carrier shipping services.

38. The method of claim 37, wherein the first shipping consolidator services rules include routing rules and shipping label generation rules.

39. The method of claim 32, wherein the carrier library provides carrier support modules for each of the shipping service providers, and wherein the carrier support modules are configured to interface services logic for a corresponding shipping service provider with the shipping management platform via instances of consolidator carrier components.

40. The method of claim 39, wherein the carrier support modules each comprise a set of services that are selectable by the first shipping consolidator for offering through the shipping management system as supported by the first shipping consolidator.

41. The method of claim 40, wherein one or more of the carrier support modules comprise logic to provide routing based off of the first shipping consolidator services rules.

42. The method of claim 40, wherein one or more of the carrier support modules comprise logic to provide tracking based off of the first shipping consolidator services rules.

43. The method of claim 40, wherein one or more of the carrier support modules comprise logic to support compliance with shipping rules of the corresponding shipping service provider.

44. The method of claim 40, wherein one or more of the carrier support modules comprises logic to support labeling, rating, and manifesting with respect to the corresponding shipping service provider.

45. The method of claim 39, wherein the carrier support modules include one or more native carrier support modules providing, internally with respect to the carrier support logic, label rules, rating algorithms, and routing rules of the services logic of the corresponding shipping service provider.

46. The method of claim 45, wherein the carrier support modules include one or more interfaced carrier support modules providing, externally with respect to the carrier support logic via an interface, label rules, rating algorithms, and routing rules of the services logic of the corresponding shipping service provider.

47. The method of claim 32, further comprising:
configuring a second instance of the generic consolidator carrier component for the first shipping consolidator to provide a second consolidator carrier component of the carrier support logic in the shipping management system for the first shipping consolidator; and
interfacing the second consolidator carrier component with the shipping management system to further expose the first shipping consolidator as a carrier option available to the users of the shipping management system, wherein the first consolidator carrier component is exposed by the shipping management platform for transactions corresponding to a first induction location of the first shipping consolidator and the second consolidator component is exposed by the shipping management platform for transactions corresponding to a second induction location of the first shipping consolidator.

48. The method of claim 47, further comprising:
configuring a third instance of the generic consolidator carrier component for a second shipping consolidator to provide a third consolidator carrier component for the second shipping consolidator; and
interfacing the third consolidator carrier component with the shipping management platform to expose the second shipping consolidator as another carrier option available to the users of the shipping management system.

49. The method of claim 47, wherein a user name and password of the users map to a specific instance of the first and second consolidator carrier component.

50. The method of claim 32, further comprising:
altering one or more aspects of the first consolidator carrier component to dynamically change at least one service exposed for the first shipping consolidator to users through the shipping management system.

51. The method of claim 50, wherein altering the one or more aspect of the first consolidator carrier component comprises:
switching selection of a first carrier support module of the carrier library for selection of a second carrier support module of the carrier library to dynamically change a carrier providing shipping services exposed for the first shipping consolidator by the shipping management system.
